(19) United States
(12) Patent Application Publication
(10) Pub. No.: US 2015/0221180 A1
(43) Pub. Date: Aug. 6, 2015

(54) CARD GAME

(71) Applicant: TCS John Huxley Europe Limited, London (GB)

(72) Inventor: Cao J.C. Araico, Brussels (BE)

(73) Assignee: TCS John Huxley Europe Limited, London (GB)

(21) Appl. No.: 14/170,863

(22) Filed: Feb. 3, 2014

(51) Int. Cl. G07F 17/32

(52) U.S. Cl. CPC G07F 17/3293; G07F 17/326

(57) ABSTRACT

A method of playing a wagering card game by at least one player, comprising the steps of drawing a plurality of cards from a deck of cards to form a group of cards without revealing the identities of the group of cards. Providing the opportunity for a player to place a wager by predicting a winning criteria related to a possible card identity. Randomly selecting one of the group of cards and revealing the identity of the selected card. Comparing the identity of the selected card to the criteria of the player wager. Settling the player's wager on the basis of the comparison.

A gaming machine, gaming system, a non-transitory computer readable medium including a software program or a plurality of software programs, and a gaming table for playing the game, and a method of playing the wagering card game using a gaming apparatus.

### TECHNICAL FIELD OF THE INVENTION

This disclosure relates to card games, and particularly provides a card game in which many players can wager on the value of a selected card.

### BACKGROUND

There are many different card games played in casinos (or other gaming venues) and online, having different card dealing and wagering rules, and rules for valuing and ranking hands. These card games include, for example, Baccarat and Blackjack.

A drawback of some known games is that each game being played can only accommodate a relatively small number of players. For example a game of Baccarat is played between a banker and a single player. As a result, it may be difficult to provide enough games for all of the potential players to play simultaneously, resulting in players having to wait for a place at a game to become available. Further, a drawback of some games where more players can be accommodated in each game is that there is generally a requirement for each player in turn to take actions and/or make decisions, which can lead to relatively slow game play.

This is a problem because having to wait for a place in a game to become available, and slow game play, may both result in players becoming bored and stopping playing.

### SUMMARY OF THE INVENTION

According to a first aspect of the present disclosure, there is provided a method for playing a wagering card game by at least one player, comprising the steps of: drawing a plurality of cards from a deck of cards to form a group of cards without revealing the identities of the group of cards; providing the opportunity for a player to place a wager by selecting a winning criteria related to a possible card identity; randomly selecting one of the group of cards and revealing the identity of the selected card; comparing the identity of the selected card to the criteria of the player wager; and settling the player's wager on the basis of the comparison.

The methods of the first aspect may be implemented as a live table game, where physical cards are dealt on a table either by a dealer in person or by a card dealing machine, and players present can place wagers on the outcome of the game. Alternatively, the methods may be implemented as an electronic gaming application, either played online via a fixed or a mobile device, or on a dedicated gaming machine for example at a casino.

A second aspect of the present disclosure provides a gaming machine comprising: a display screen for displaying a selected card to a player; input means to allow a player to input wager information comprising a prediction of a winning criteria related to a possible card identity; a memory for storing the wager information; a processor operable to: receive the wager information and store it in the memory; randomly generate a plurality of cards from a deck of cards to form a group of cards without revealing the identities of the group of cards; randomly select one of the group of cards and reveal the identity of the selected card; and determine the result of the wager by comparing the identity of the selected card to the criteria of the stored player wager; determine an amount of winnings payable to the player; and communicate the amount of winnings to the player, via the display screen.

A third aspect of the present disclosure provides a gaming system comprising a gaming server and a plurality of gaming terminals, the gaming server and the said plurality of gaming terminals being linked by a communications network, wherein each of the gaming terminals comprises: a display screen for displaying a selected card to a player; and input means to allow a player to input wager information comprising a prediction of a winning criteria related to a possible card identity; and wherein the gaming server comprises: a card generator for generating card data representing randomly-selected playing cards; a memory in which is stored: a payout table storing correlations between a selected card identity, a predicted result, and an amount to be paid; and received player wager information; and a processor operable to: randomly generate a plurality of cards from a deck of cards to form a group of cards without revealing the identities of the group of cards; receive betting information from at least one player terminal; randomly select one of the group of cards and reveal the identity of the selected card; transmit card data for the selected card to the gaming terminals for display; determine a result of the wager by comparing the identity of the selected card to the criteria of the stored player wager; and settle each player's wager on the basis of the predicted result, the selected card, and the payout table.

A fourth aspect of the present disclosure further provides a non-transitory computer readable medium including a software program or a plurality of software programs which, when executed, enables a gaming machine to provide to at least one player a wagering card game comprising the steps of: receiving wager data representing a players wager, the wager data comprising a prediction of a winning criteria related to a possible card identity, from a player at a player terminal; randomly generating a plurality of cards from a deck of cards to form a group of cards without revealing the identities of the group of cards; randomly selecting one of the group of cards and reveal the identity of the selected card; and determining the result of the wager by comparing the identity of the selected card to the criteria of the stored player wager; determining an amount of winnings payable to the player; and settling the players wager on the basis of the determined result of the deal and the bet data.

A fifth aspect of the present disclosure provides a gaming table for playing the card game of claim 1, the gaming table comprising: a dealer position intermediate the length of a first side of the table; a card dealing area delineated on the table adjacent the dealer position, to receive the group of cards; a number of player positions spaced along a second side of the table opposite the first side; a plurality of wager regions distributed across the gaming table, with different wager regions corresponding to respective predicted winning criteria related to a possible card identity.

A sixth aspect of the present disclosure provides a method of playing a wagering card game by at least one player, using a gaming apparatus comprising: one or more decks of playing cards; a card shuffling and dealing apparatus; a gaming table having delineated thereon: a card dealing area; a number of player positions; a plurality of wager regions distributed across the gaming table, with different wager regions corresponding to respective predicted winning criteria related to a possible card identity; random selection means; and tokens for representing the value of a wager; the method comprising the steps of: delivering, from the shuffling and dealing apparatus, a plurality of cards from a deck of cards to form a group of cards face down on the card dealing area; the player placing a wager on a possible game outcome, by positioning a number of tokens to the amount of the wager in a wager region associated with the player's predicted winning criteria; using the random selection means, randomly selecting one of the group of cards and placing the selected card face up on the card dealing area; determining the outcome of the game by comparing the identity of the selected card to the criteria of the player wager, by either: placing a number of additional tokens in the wager region in which the tokens forming the wager were positioned; or removing the tokens positioned in the wager region by the player.

A seventh aspect of the present disclosure provides a method of playing a wagering card game by at least one player, comprising the steps of: associating card identities of a deck of cards with different ones of a plurality of colours; providing the opportunity for a player to place a wager by predicting the colour associated with a card to be selected; selecting a card; determining whether the player prediction is correct by determining whether the colour associated with the card identity of the selected card is the same as the player prediction; if the player prediction is correct, repeating the same player prediction for a subsequent selected card; comparing the number of consecutive times the player prediction is correct to a results table; and settling the player's wager on the basis of the comparison.

Another aspect of the present disclosure provides a card game with first and second successive random or pseudo random selection steps, in which the first random or pseudo random selection step selects a plurality of cards, and the second random or pseudo random selection step selects from the purality of cards.

Another aspect of the present disclosure provides a card game in which a first group of cards is selected from a second group of cards, and a subsequent selection is made from the first group of cards to select a card for use in game play.

The electronic device or the gaming terminal can be selected from a computer, an electronic game table, a gaming machine, a mobile phone, a tablet or pad computer, and a smartphone. The game server may be a network device other than a server, and may for example be a desktop or laptop computer.

An advantage of the present disclosure is that a number of players can play the game without slowing game play, as the placing of wagers may be carried out simultaneously by the different players. The placing of wagers regarding the identity of a card selected from a group of cards which have already been drawn and placed face down, or with their identities otherwise concealed, may increase player interest in the game. The provision of a progressive side game may provide players who do not win the main game with an ongoing possibility to win the side game, and this may increase player interest in the main game and side game combination.

### BRIEF DESCRIPTION OF DRAWINGS

Embodiments of the invention will now be described by way of example only with reference to the accompanying drawing, in which:

FIG. 1 is a diagram illustrating a method for playing a card game with rules according to one embodiment of the present disclosure;

FIG. 2 is a plan view of a table adapted for playing the game;

FIG. 3 is a plan view of a playing surface adapted for playing the game;

FIG. 4 shows a schematic view of the general arrangement of a card selection apparatus adapted for playing the game;

FIG. 5 shows a schematic view of a control unit of the card selection apparatus of FIG. 4;

FIGS. 6a to 6d show plan views of card stations of the card selection apparatus of FIG. 4 in a different states in use;

FIG. 7 shows a flow chart of operation of the card selection apparatus of FIG. 6;

FIG. 8 is a plan view of a playing surface adapted for playing the game;

FIG. 9 is a schematic view of a gaming machine according to one embodiment of the present disclosure;

FIG. 10 shows a flow chart of operation of the gaming machine of FIG. 9;

FIGS. 11a to 11d show stages of operation of a shuffling method used by the gaming machine of FIG. 9;

FIG. 12 is a schematic view of a gaming system according to one embodiment of the present disclosure;

FIG. 13 shows a flow chart of operation of a side game according to the present disclosure.

### DETAILED DESCRIPTION

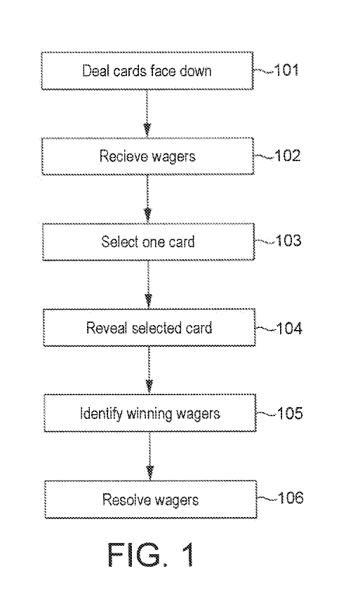

FIG. 1 illustrates a method 100 for playing a card game with rules according to one embodiment of the first aspect of the present disclosure.

The method starts at a step 101 by dealing out six cards and laying them face down. The six cards are dealt from a shuffled stack of cards containing one or more decks of standard playing cards with jokers. Accordingly, the six cards dealt have random identities. In a preferred example the stack of cards contains five or six decks of standard playing cards, with each deck having two jokers.

In a “real world” example of the game the dealing may be carried out by a croupier or dealer.

Then, at a step 102 wagers are received from one or more players, each wager being based on one or more selected features of the identity of a possible card, and an amount element indicating a monetary or other value for the wager. The wagers are taken by the organization or individual running the game, referred to as the house.

The wagering rules may optionally allow secondary, side or jackpot bets, such as progressive jackpot bets, to be made by players in the manner of secondary, side or jackpot wagering in poker and blackjack. In “real-world” games, wagers may be made by placing actual cash or gambling chips on a betting area of a gaming table, or by inserting cash or tokens into a gaming machine.

In a variant method, players may be allowed to begin placing wagers before the six cards have been dealt and laid out face down.

When all players have placed their wagers, the method moves onto step 103 where one of the six face down cards is randomly selected.

The method 100 then moves to step 104, where the randomly selected card is turned over to reveal its identity.

The method 100 then moves on to step 105, in which the winning and losing wagers are identified, based on a comparison of the identity of the selected card to the selected features of the different wagers. If the selected card matches the criteria of a wager the wager is regarded as a winning wager.

The final step 106 in the method 10 is to resolve the wagers placed by the players and pay winners. The amount won by a player placing a winning wager may depend on the amount wagered and the payout odds assigned to the wager placed by a payout schedule. The losing wagers are retained by the house.

The wager criteria may include the specific identity of the selected card or various combinations of the card value and suit.

Accordingly, in the game a card is selected from a deck of cards by dealing a number of cards face down, and then randomly selecting one of the face down cards for use in the game.

This process may increase the degree of randomness of the selected card beyond what would be obtained by taking a card directly from the deck, regardless of how thoroughly the deck has previously been shuffled.

Further, the selection of one card from six of cards which have already been dealt face down may make it evident to observers that the card has been randomly selected because once the cards have been dealt face down it will not be possible for the cards to be exchanged or identified before the selected card is turned over. Accordingly, since wagers are placed after the six cards have been dealt face down but before the card is selected. Accordingly, users can be reassured that the identities of the six cards, which have already been dealt out face down, cannot have been selected or changed in response to the wagers made.

Examples of possible wagers, and the payout odds for winning these possible wagers according to a possible payout schedule are set out below in Table 1. A player placing a winning wager will have the wagered amount, also known as the stake, returned, and also receive winnings equal to the wagered amount multiplied by the payout odds for the winning wager.

Table 1 also shows the probability that the selected card matches each possible wager, the real odds that would correspond to players on average making no profit or loss, and the percentage that the house will on average retain, known as the house percentage or house edge, for each wager.

TABLE 1

| | | Real | Payout | House |
|---|---|---|---|---|
| Wager | Probability | Odds | odds | Percentage |
| Specific card | 1/54 | 53:1 | 51:1 | 1.8518 |
| Joker | 2/54 | 26:1 | 25:1 | 3.7037 |
| Red card | 26/54 | 14:13 | 1:1 | 48.1481 |
| Black card | 26/54 | 14:13 | 1:1 | 48.1481 |
| Even number | 20/54 | 17:10 | 16:10 | 37.037 |
| Odd number | 20/54 | 17:10 | 16:10 | 37.037 |
| Low number (A-5) | 20/54 | 17:10 | 16:10 | 37.037 |
| High number (6-10) | 20/54 | 17:10 | 16:10 | 37.037 |
| Any Jack | 4/54 | 25:2 | 12:1 | 7.4074 |
| Any Queen | 4/54 | 25:2 | 12:1 | 7.4074 |
| Any King | 4/54 | 25:2 | 12:1 | 7.4074 |
| Any Ace | 4/54 | 25:2 | 12:1 | 7.4074 |
| Specific number | 4/54 | 41:13 | 12:1 | 7.4074 |
| Specific Suit | 13/54 | 41:13 | 12:1 | 24.0741 |

For the purposes of the odd number and even number wagers an ace is regarded as an odd number.

For the purposes of the low number and high number wagers an ace and numbered cards two to five are regarded as low numbers and numbered cards six to ten are regarded as high numbers.

The picture cards (Jack, Queen, King) and Jokers are regarded as having no numerical value, and so will not match wagers on odd numbers, even numbers, high numbers or low numbers.

Jokers are regarded as having no suit or colour, and so will not match wagers on red, black or specific suits.

As is explained above, Table 1 shows only some examples of possible wagers. Other possible wagers can easily be defined, for example, any picture card, a picture card with a specific suit, a number in the range 4 to 7, any even numbered red card, etc.

The probability of any specific card being the selected card is known. Accordingly, the probability of any defined wager winning can be easily calculated. Appropriate payout odds ensuring a positive house percentage can then be assigned to the defined wager based on this probability of winning.

In theory a very large number of possible wagers can be defined, and in practice it may be preferred to limit the number of possible wagers made available to players in order to avoid players become confused by the number of possible wagering options. The selection of which possible wagers to offer may be made on a case by case basis.

As can be seen in Table 1 the house percentage of the different wagers varies. As a result, the overall house percentage will vary depending on which possible wagers are supported in any specific example, and the proportion of the different possible wagers made by players. However, since all of the wagers in Table 1 have a positive house percentage the house will on average make a profit regardless of which wagers players chose to make.

If wagers were evenly distributed across all of the possible wagers in Table 1, on average the house percentage should be about 3.7%.

The method of the invention can be implemented as a live table game in a casino (or other gaming venue) and performed manually using physical cards, non-electronic gaming tables and physical wagering chips. The method may also be implemented in computer software and performed electronically using virtual playing cards on a networked or standalone electronic device selected from computers, electronic game tables, gaming machines, mobile phones, and smartphones. Other equivalent electronic devices may also be used. The method may also be implemented partly manually and partly electronically, for example, on a hybrid electronic gaming table with physical cards.

The method of the invention may also be implemented as an online gaming application in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combinations of such back-end, middleware, or front-end components. The components of the system may be interconnected by any form or medium of digital data communication (e.g., a communication network). Examples of communication networks include a local area network (“LAN”), a wide area network (“WAN”), and the internet.

Examples of the invention, which are illustrative only and are not intended to limit the scope of the invention, will now be described in more detail.

The description above, and the examples relate to a version of the game in which six cards are initially dealt and laid out face down, and one of the six cards is then selected, with wagers being made on the identity of the selected card. Other versions of the game may be played in which a different number of cards are initially laid face down, and/or a different number of cards are selected. In versions where a different number of cards are selected, wagers may be made on the identities of one, some or all of the selected cards, and/or on collective properties of the selected cards. It may be preferred not to play the game with four or seven cards being initially dealt, as these numbers are considered unlucky by some cultures.

### Example 1

In a casino live table game example, players place their wagers or bets based on selected features of the identity of the randomly selected card.

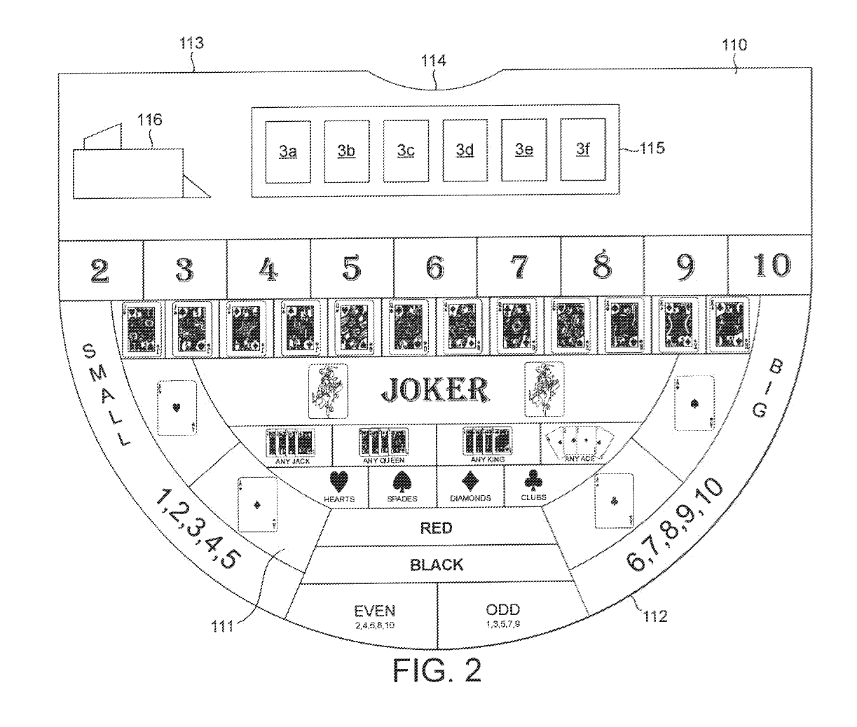

In the first example illustrated in FIG. 2, the table game is played on a generally semicircular table 110 having a generally semicircular playing area 111 having a gaming layout for placing wagers, seen in plan view in FIG. 2. In the first example the generally semicircular table may for example be a conventional Blackjack table bearing the illustrated gaming layout. The gaming table 110 has a generally curved edge 112 and a generally straight edge 113. A number of playing positions are spaced around the curved edge 112 of the gaming table 110, and a dealer position is defined at the centre of the straight edge 113, possibly by a slight recess 114 in the straight edge of the semicircular table 110.

Conveniently, in front of or adjacent to the dealer position, a cardholding area 115 is defined. The cardholder area 115 includes six card receiving positions 3a to 3f.

The card receiving positions 3a to 3f may be formed by a card selection apparatus, as will be discussed in detail below. Alternatively, the card receiving positions 3a to 3f may be formed by depressions in, or raised areas of, the tabletop, or may simply be delineated on the surface of the table by lines or raised ridges, by an area of contrasting colour, or in any other suitable manner.

In this embodiment, cards are provided from a card shuffling and dealing apparatus 116, which sequentially delivers randomly-selected cards from a supply of cards held within the apparatus 116. As discussed above, the supply of cards is five or six decks of conventional playing cards, with each deck having two Jokers. Alternatively, a conventional shoe containing five or six standard decks each with two Jokers may be used. The decks of playing cards may be shuffled twice by a mechanical card shuffler before use, that is, shuffled, and then shuffled again.

In alternative embodiments a dealing shoe with more or fewer decks of cards may also be used, or the dealer may simply hold a pack of cards in his hands and deal cards manually.

The playing area 111 is divided into a number of regions providing different alternative options for wagers. A player may place cash or gambling chips on a region of the playing area to place a bet that the selected card will match the criteria defined by that region.

For example, a player placing cash or gambling chips on the region of the playing area 111 labelled “small 1, 2, 3, 4, 5” will place a bet that the selected card will be an Ace or one of the numbered cards 2 to 5 of any suit. This corresponds to the Low number wager of Table 1.

In the illustrated example the playing area 111 also includes a region labelled “large 6, 7, 8, 9, 10” which places a bet that the selected card will be one of the numbered cards 6 to 10 of any suit. This corresponds to the High number wager of Table 1.

Further, the playing area 111 also includes regions labelled “2”, “3”, “4”, “5”, “6”, “7”, “8”, “9” and “10”, which each place a bet that the selected card will have the respective number value of any suit. These each correspond to a different Any number wager of Table 1.

Further, the playing area 111 includes a region labelled “Odd”, which places a bet that the selected card will be an Ace or one of the numbered cards 3, 5, 7 or 9 of any suit. This corresponds to the Odd number wager of Table 1.

Further, the playing area 111 includes a region labelled “Even”, which places a bet that the selected card will be one of the numbered cards 2, 4, 6, 8 or 10 of any suit. This corresponds to the Even number wager of Table 1.

Further, the playing area 111 includes a region labelled “Red”, which places a bet that the selected card will be a heart or diamond suit. This corresponds to the Red card wager of Table 1.

Further, the playing area 111 includes a region labelled “Black”, which places a bet that the selected card will be a club or spade suit. This corresponds to the Black card wager of Table 1.

Further, the playing area 111 includes region labelled “Hearts”, “Spades”, “Diamonds” and “Clubs”, which each place a bet that the selected card will be the respective specified suit. These each correspond to a different Specific suit wager of Table 1.

Further, the playing area 111 includes regions labelled “Any Jack”, “Any Queen”, “Any King” and “Any Ace”, which each place a bet that the selected card will be the respective value card of any suit. These each correspond to a respective one of the Any jack, Any queen, Any king and Any ace wagers of Table 1.

Further, the playing area 111 includes regions bearing the image of each of the Jack, Queen, King and Ace of each suit, which each place a bet that the selected card will be the imaged value and suit. These each correspond to a different specific card wager of Table 1.

Further, the playing area 111 includes a region labelled “Joker” and bearing the image of the Joker, which each place a bet that the selected card will be a Joker. This corresponds to a Joker wager of Table 1.

In the first example the game is played by a croupier or dealer dealing out six cards from the card shuffling and dealing apparatus 116 one by one, and placing each card in turn face down on a respective one of the card receiving positions 3a to 3f.

Then, wagers are made by the players placing cash or gambling chips on the regions of the playing area 111 corresponding to the desired wagers. These wagers are received and accepted by the dealer.

When all of the players have placed their desired wagers, the dealer announces that no more bets will be taken. Then, one of the six face down cards is randomly selected, and the randomly selected card is turned over by the dealer to display the identity of the selected card to the players.

Conveniently, the selected card may be removed from a face down position on its respective card receiving position by the dealer, turned over, and placed face up again on the same card receiving position.

Wagers placed by the players are then resolved, in accordance with a predefined payout schedule, in this example the payout schedule according to Table 1. In other examples, different payout schedules may be used.

The dealer then identifies and pays out any winning wagers, collects the stakes of losing wagers, and removes all of the six cards, both the selected card and the unselected cards, from the card receiving positions.

Once all the winning players have received their payouts, and the stakes of losing players have been collected by the house, play restarts for another round of the game.

In an alternative example players may be allowed to place wagers before the six cards are dealt face down. However, it is expected that players will find it more interesting and exciting to place their wagers after the six cards have been dealt.

In game play where the dealer performs all of the card manipulations and the players do not touch the playing cards, the cards may be subsequently shuffled and re-dealt, for example by being returned to an automatic card shuffling and dealing device in examples where this is used. Alternatively, games in which the players may be permitted to handle the cards, for example where a player turns over the selected card, in order to avoid any suspicion of card tampering, the cards may be destroyed or discarded after each game.

In examples where the removed cards are not returned to the card shuffling and dealing apparatus 116, or where a conventional shoe is used, each time the game is played the number of cards in the supply will be reduced by six. In such examples the supply of cards may be replaced when the number of remaining cards reaches a predetermined minimum value, in order to prevent players card counting in order to predict what cards are still present in the pack. Such card counting could otherwise allow players to distort the game odds and unfairly profit.

Similarly, in examples where the dealer deals and shuffles manually from a single pack of cards the removed cards should be returned to the pack and reshuffled before the next game in order to prevent card counting.

### Example 2

In this example, game play is similar to the example set out above with the difference that a different playing area is used.

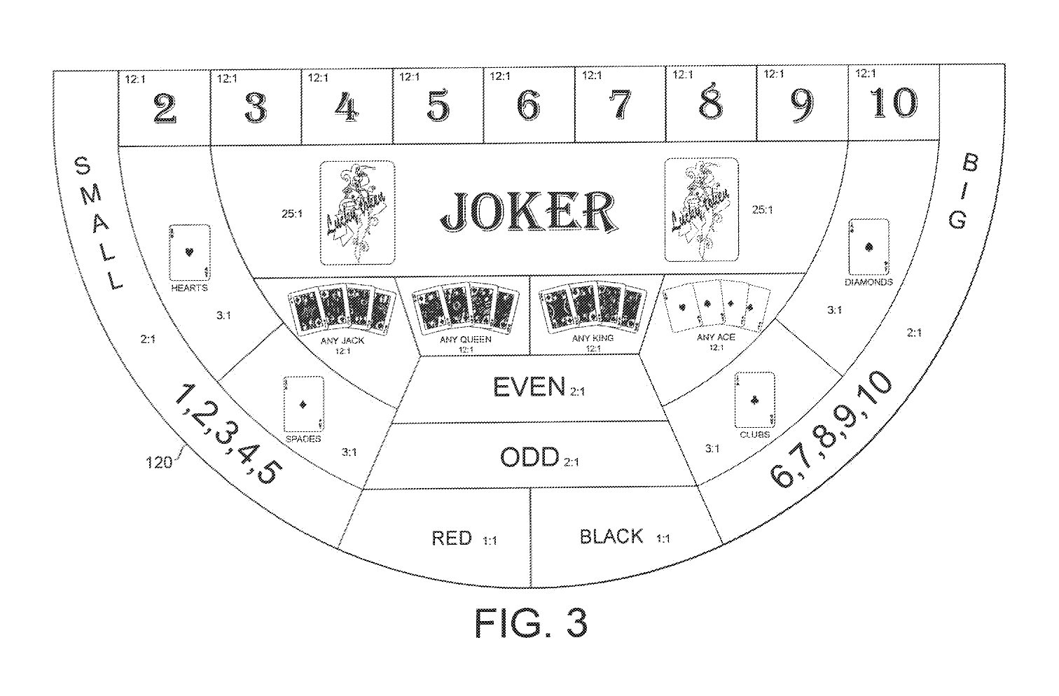

In a real-world example, the game is played on a casino table similar to that described in relation to Example 1, except that a different playing area 120 illustrated in FIG. 3 is used.

The playing area 120 differs from the playing area 111 according to the first example mainly in that the playing area 120 does not include any regions corresponding to a wager on any specific card identities for the selected card. Thus, compared to the playing area 111, the regions bearing the image of each of the Jack, Queen, King and Ace of each suit, which each place a bet that the selected card will be the imaged value and suit each corresponding to a specific card wager of Table 1 are not present in the playing area 120.

The reduced number of regions in the playing area 120 may provide a less cluttered playing area, and so may make it easier for players to follow the game and decide what wagers to place. Further, the reduced number of regions corresponds to a reduction in the number of different bets available, so this may make it easier for players to decide what wagers to place. Accordingly, both of these changes may speed up game play, allowing more games to be played in a set period.

Further, the removed specific card wagers have a low probability of winning. Accordingly, by removing these wager options so that players will make wagers having a higher probability of winning the number and/or rate of wins taking place during play may be increased. This may increase the level of player excitement and interest in the game, and may encourage non-playing observers to begin playing.

The playing area 120 also differs from the playing area 111 by each region of the playing area 120 including the payout odds of the wager corresponding to that region. This may assist players understanding of the game.

The payout odds may be included in the wager indicating regions in any example of the invention.

In the described examples, the cards which are available for selection are placed face down. This is not essential. In other examples the identities or values of the cards may additionally, or alternatively, be concealed in other known ways.

### Example 3

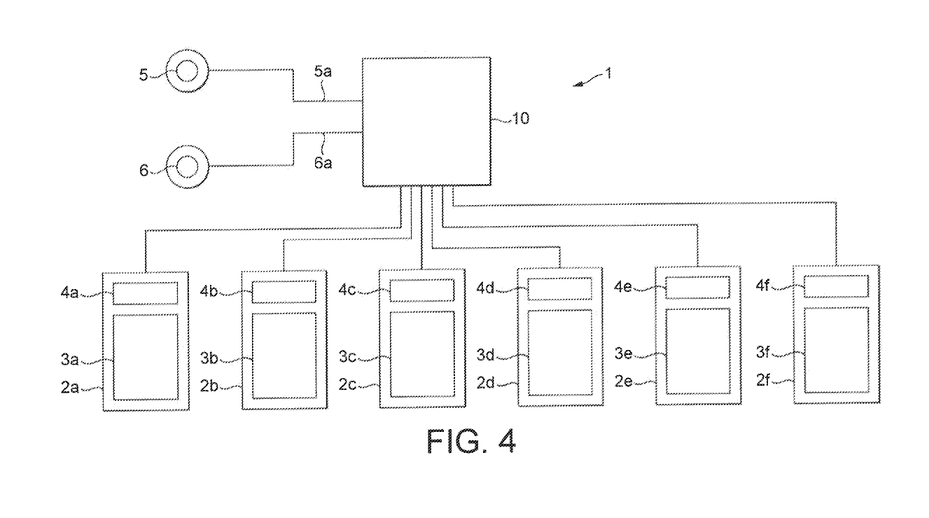

In this example the game is played using an electronic card selecting apparatus illustrated schematically in FIG. 4. The electronic card selecting apparatus carries out the function of randomly selecting one card for use in the game from the six face down cards.

FIG. 4 shows a schematic view of the general arrangement of a card selection apparatus 1 adapted for playing the game.

The card selection apparatus 1 comprises six card stations 2a to 2f. Each card station 2a to 2f defines a respective card receiving position 3a to 3f sized and shaped to receive a playing card, and a light 4a to 4f associated with the respective card receiving position 3a to 3f. Each card station 2a to 2f has its respective light 4a to 4f located adjacent to its respective card receiving position 3a to 3f so that when its respective light 4a to 4f is illuminated this provides an unambiguous visual indication of its respective card receiving position 3a to 3f.

In the illustrated embodiment each of the lights 4a to 4f is a light emitting diode (LED). In other examples other forms of light source may be used.

The card selection apparatus 1 also comprises a control unit 10 connected to the card stations 2a to 2f. The control unit 10 controls the illumination of the lights 4a to 4f. The card selection apparatus 1 further comprises a first user input means comprising a first push button 5 and a second user input means comprising a second push button 6 to allow users to control operation of the card selection apparatus 1. The first and second push buttons 5 and 6 are connected to the control unit 10.

In the illustrated example each of the first and second user input means is a push button. In other examples other forms of user input means may be used.

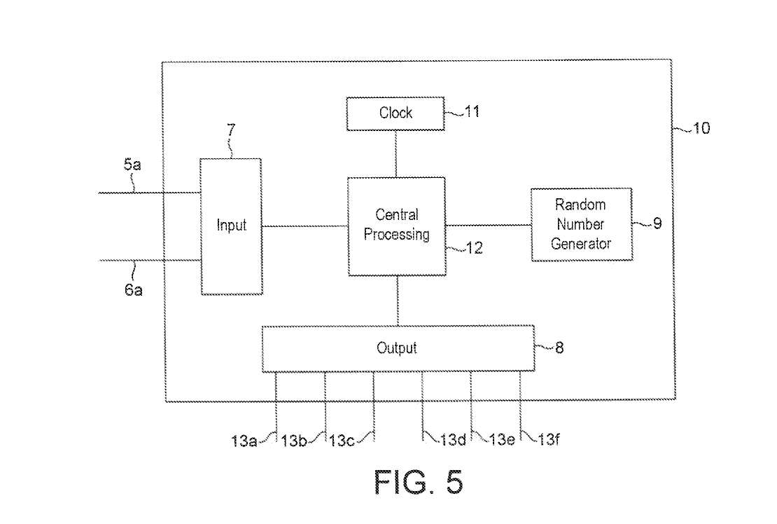

FIG. 5 shows a schematic view of the control unit 10. The control unit 10 comprises an input module 7, an output module 8, a random number generator module 9, a clock module 11, and a central processing module 12.

The input module 7 is arranged to receive control signals from the first and second push buttons 5 and 6 along respective control signal lines 5a and 6a, and to provide the received control signals to the central processing module 12.

The output module 8 is arranged to receive a card receiving station selection signal from the central processing module 12, and to provide a driving signal to the light 4a to 4f of the selected card station 2a to 2f along a respective drive signal line 13a to 13f.

The random number generator module 9 is arranged to receive a request for a random number from the central processing module 12, and to respond to this request by providing a random number to the central processing module 12.

The clock module 11 provides a clock signal to the central processing module 12.

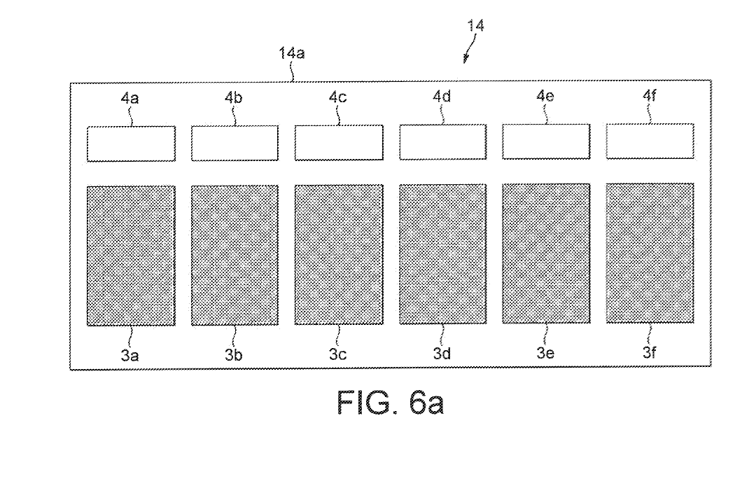

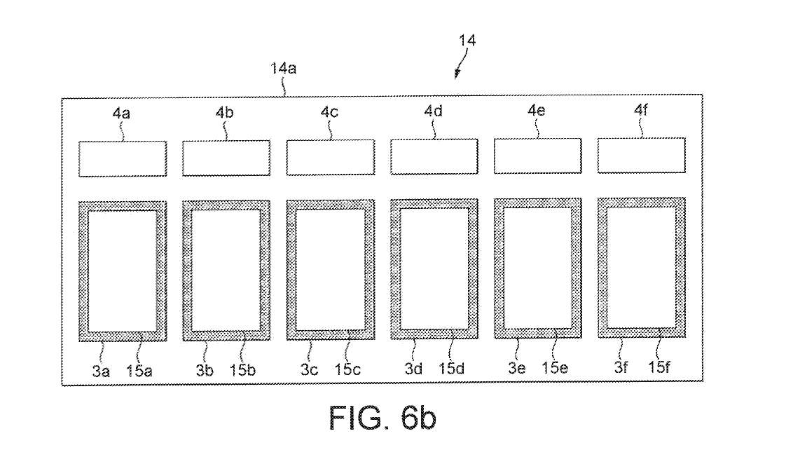

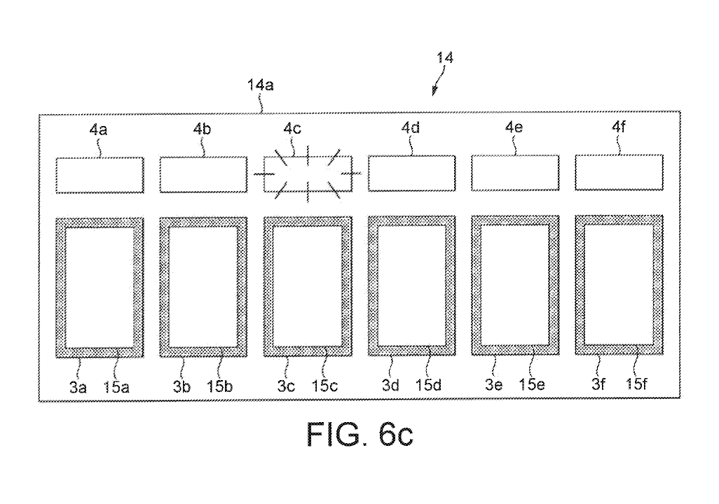

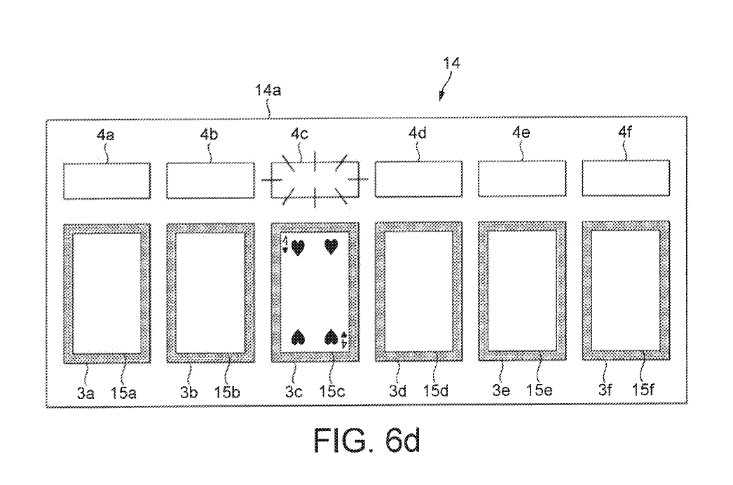

FIGS. 6a to 6d show plan views of the card stations 2a to 2f of the card selection apparatus 1 at different stages of a card selection operation using the card selection apparatus 1 to play the game.

As can be seen in FIGS. 6a to 6d, the six card stations 2a to 2f are provided by a single common card display body 14. When the card selection apparatus 1 is used in the first or second examples the card display body may occupy the cardholder area 115.

FIG. 6a shows the card display body 14 in a starting state before commencing the card selection operation. In the starting state shown in FIG. 6a there are no cards present on the card display body 14 and the lights 4a to 4f are not illuminated.

Each of the card stations 2a to 2f comprises a respective card receiving position 3a to 3f located on an upper surface 14a of the card display body 14. Each of the six card receiving positions 3a to 3f comprises a respective rectangular area having two long edges and two short edges, and being sized and shaped to receive a playing card. The rectangular areas of the different card receiving positions 3a to 3f are all the same size and shape, and are arranged spaced apart side by side in a line, with the long sides of adjacent rectangular areas in parallel.

Preferably, the rectangular areas of the card receiving positions 3a to 3f are marked in a plain colour contrasting with the remainder of the upper surface 14a of the display body 14. In the illustrated example the rectangular areas are white and the remainder of the upper surface 14a is black. In other examples different colours may be used.

Each of the card stations 2a to 2f also comprises a respective light 4a to 4f associated with the respective card receiving position 3a to 3f. Each of the lights 4a to 4f is located adjacent a short edge of the rectangular area of the associated card receiving position 3a to 3f, with all of the lights 4a to 4f being located on the same side of the line of rectangular areas. Each of the lights 4a to 4f extends in a direction parallel to the short edges of the rectangular areas for a distance approximately equal to the length of the short edges of the rectangular area of the associated card receiving position 3a to 3f.

The location of the lights 4a to 4f adjacent to the respective card receiving positions 3a to 3f with which they are associated ensures that each light 4a to 4f can provide an unambiguous visual indication of the associated card receiving position 3a to 3f when the light 4a to 4f is illuminated.

In operation of the card selection apparatus 1 to play the game, six cards 15a to 15f are dealt by the dealer, and each card 15a to 15f in turn is placed face down on the upper surface 14a of the display body 14 on a different one of the card receiving positions 3a to 3f of the card stations 2a to 2f, as shown in FIG. 3b.

When the six cards 15a to 15f have been dealt face down onto respective card receiving positions 3a to 3f, the dealer presses the first push button 5 to generate a deal complete signal to notify the control unit 10 that the six cards 15a to 15f have been dealt.

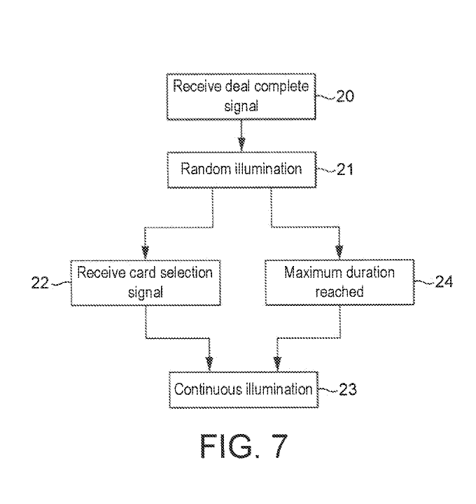

The method followed by the card selection apparatus 1 is shown in the flow chart of FIG. 7.

In a receiving step 20, the card selection apparatus 1 receives a user input notifying that the deal is complete, in the illustrated embodiment this user input is made by the dealer pressing the first push button 5.

The deal complete signal generated by the first push button 5 is sent to the control unit 10, where the input module 7 sends the deal complete signal to the central processing module 12. The central processing module 12 identifies the deal complete signal and begins the method.

Next, in a random illumination step 21, in response to the deal complete signal the card selection apparatus 1 successively illuminates random ones of the lights 4a to 4f, each for a predetermined short time period. As is explained above, each light 4a to 4f is associated with a respective card receiving position 3a to 3f. Accordingly, each of the predetermined short time periods is associated with a random one of the lights 4a to 4f being illuminated and with the corresponding one of the card receiving position 3a to 3f.

The central processing module 12 is provided with a series of random numbers by the random number generator module 9. The central processing module 12 uses the current random number in the series to chose one of the lights 4a to 4f to be illuminated, and then instructs the output module 8 to supply power to only the chosen one of the lights 4a to 4f. The output module 8 then supplies power to the chosen one of the lights 4a to 4f along the corresponding respective one of the power lines 13a to 13f.

In one example the different ones of lights 4a to 4f may each be assigned a number in the range 1 to 6, and the random number generator module may provide random numbers in the range 1 to 6. In response to each random number value the light which has been assigned the same value may be chosen. Different choosing methods may be used in other examples.

After a predetermined time period, the central processing module 12 uses the next random number in the series to chose one of the lights 4a to 4f to be illuminated, and then instructs the output module 8 to supply power to only the chosen one of the lights 4a to 4f. The output module 8 then supplies power to the chosen one of the lights 4a to 4f along the corresponding respective one of the power lines 13a to 13f. Accordingly, randomly selected ones of the lights 4a to 4f are illuminated for each of a series of the predetermined time periods.

It should be noted that since the choosing of the light to be illuminated is random, this may result in a different one of the lights 4a to 4f, or the same one of the lights 4a to 4f, being illuminated in successive time periods of the series of time periods.

This process of randomly choosing one of the lights 4a to 4f and illuminating it for a predetermined period of time is repeated in the random illumination step 21, until the card selection apparatus 1 receives a user input of a card selection signal, or a predetermined maximum duration of the random illumination step 21 is reached without the card selection signal being received.

When the process of randomly choosing one of the lights 4a to 4f and illuminating it for a predetermined period of time is repeated in the random illumination step 21, the predetermined time for which the chosen light is illuminated before the random choosing is repeated is reduced on successive occasions of choosing until the predetermined time reaches a lower limit. This reduction in the successive illumination times may generate a perception of acceleration of events in players, and prompt players to input a card selection signal.

The provision of a lower limit is not essential. However, it may be preferred to select a lower limit based on the persistence of vision phenomenon in humans, so that when the predetermined time is at the lower limit observers will still be able to perceive successive illuminations of different lights.

In a first alternative procedure, the card selection apparatus 1 receives a user input of a card selection signal before the predetermined maximum duration has expired in a receive card selection signal step 22, in the illustrated embodiment this user input is made by a player pressing the second push button 6.

The card selection signal generated by the second push button 6 is sent to the control unit 10, where the input module 7 sends the card selection signal to the central processing module 12. The central processing module 12 then identifies the card selection signal and proceeds to a continuous illumination step 23.

Next, in the continuous illumination step 23, the card selection apparatus 1 continuously illuminates the chosen one of the lights 4a to 4f which was being illuminated when the card selection signal was received for a predetermined illumination time, and then stops illuminating any of the lights 4a to 4f.

In response to receiving the card selection signal, the central processing module 12 identifies which one of the lights 4a to 4f is the chosen light currently being illuminated, and then instructs the output module 8 to continue to supply power to only that identified one of the lights 4a to 4f. The output module 8 then supplies power to the identified one of the lights 4a to 4f along the corresponding respective one of the power lines 13a to 13f.

After the predetermined illumination time has expired, the central processing module 12 instructs the output module 8 to stop the supply of power to the identified one of the lights 4a to 4f, and the output module 8 then stops supplying power to the identified one of the lights 4a to 4f.

In a second alternative procedure, the predetermined maximum duration expires without the card selection apparatus 1 receiving a user input of a card selection signal, in a maximum duration reached step 24.

The central processing module 12 determines that the predetermined maximum duration has expired, and proceeds to the continuous illumination step 23.

Next, in the continuous illumination step 23, the card selection apparatus 1 continuously illuminates the chosen one of the lights 4a to 4f which was being illuminated when the predetermined maximum duration expired for a predetermined illumination time, and then stops illuminating any of the lights 4a to 4f.

In response to determining that the predetermined maximum duration has expired, the central processing module 12 identifies which one of the lights 4a to 4f is currently the chosen light being illuminated, and then instructs the output module 8 to continue to supply power to only that identified one of the lights 4a to 4f. The output module 8 then supplies power to the identified one of the lights 4a to 4f along the corresponding respective one of the power lines 13a to 13f.

After the predetermined illumination time has expired, the central processing module 12 instructs the output module 8 to stop the supply of power to the identified one of the lights 4a to 4f, and the output module 8 then stops supplying power to the identified one of the lights 4a to 4f.

The central processing module 12 uses a clock signal provided by the clock module 11 to determine when the predetermined periods of time, the predetermined maximum duration, and the predetermined illumination time, have expired.

The card selection apparatus 1 in the continuous illumination step 23 is shown in FIG. 6c. In FIG. 6c the light 4c is illuminated. It should be understood that this is only an example and any one of the lights 4a to 4f could be illuminated in the continuous illumination step 23.

As is explained above, the location of the lights 4a to 4f adjacent to the respective card receiving positions 3a to 3f with which they are associated ensures that each light 4a to 4f provides an unambiguous visual indication of the associated card receiving position 3a to 3f when the light 4a to 4f is illuminated.

Accordingly, the continuous illumination of the selected one of lights 4a to 4f provides an unambiguous visual indication of the associated card receiving position 3a to 3f, and of the face down card 15a to 15f located at that card receiving position 15a to 15f, indicating that the face down card 15a to 15f located at that card receiving position 15a to 15f is the selected card.

The dealer then turns over the indicated card 15a to 15f located on the card receiving position 3a to 3f associated with the light 4a to 4f which is illuminated in the continuous illumination step 23, and places this card 15a to 15f face up on the card receiving position 3a to 3f, as shown in FIG. 6d. In the illustrated example the indicated card turned face up is the card 15c, which is the four of hearts.

This indicated card 15a to 15f which is turned face up is the card selected by the card selection apparatus 1. In the illustrated example this selected card is card 15c, the four of hearts. The selected card is then used in the game to resolve wagers, as discussed in the previous examples.

In an alternative example the second button could be omitted and the selection of one of the card receiving positions, and the card located at that card receiving position, made directly by the card selection apparatus without any player input. In one example of this alternative embodiment the card selection apparatus could simply be arranged to always follow the second alternative procedure of selecting a card receiving station based on which light is illuminated when a predetermined maximum duration is reached, as described above. However, it will usually be preferred for a player to generate the second user signal in order to reassure players that the selection is outside the control of the dealer.

In other examples, different procedures for random selection of a card receiving stations, and the card located at that card receiving station, by the card selection apparatus could be followed, and the outcome of this selection indicated by illuminating an appropriate one of the lights.

In the described example, the selection of the light to be illuminated is random, and this may result in a different one of the lights 4a to 4f, or the same one of the lights 4a to 4f, being selected and illuminated in successive selections during the random illumination step. This is not essential. In other examples the selection of the light to be illuminated may be constrained to always select a non-illuminated light different from the currently illuminated light, but a random one of the non-illuminated lights.

In the described example, during the random illumination step the predetermined time for which a selected light is illuminated before the random selection is repeated is reduced on successive occasions of selection. This is not essential. In other examples this predetermined time may be constant.

In the described example, a first push button is used by the dealer to generate the first user input of a deal complete signal. This is not essential. In other examples, the deal complete signal may be generated by alternative user input means. In further examples, the card selection apparatus may comprise sensing means able to determine whether cards are present at the card receiving stations and generate a deal complete signal when cards are present at all of the card receiving stations without requiring any dealer input.

In the illustrated example, a single second push button is used to generate the card selection signal. In alternative examples where the game has more than one player, one of the players may be selected to push the second button and generate the card selection signal. This player selection may be carried out in any preferred manner. The player selection may for example be random, or by the dealer, or may be based on actions within the game. For example, the player making a wager having the largest stake, or the player making a wager having the highest potential winnings, may be selected to push the second button.

In alternative examples, a plurality of second push buttons may be used. In examples where the game has more than one player, each of the players may have a separate second button to generate the card selection signal. In some examples where multiple second buttons are used, one player may be selected to push their second button and generate the card selection signal in a similar manner to the examples described above where only one second button is used. In other examples inputs from the different players may be used to generate the card selection signal in any convenient manner. For example, the first player to press the second button may generate the card selection signal, or the card selection signal may be generated when a predetermined number of players have pressed their respective second buttons.

In the described examples, the control unit selectively illuminates lights by selectively providing power to the lights. This is not essential. Other control arrangements may be used. In some examples the control unit may send control signals to a local power supply associated with one or more of the lights, the control signals instructing which light was to be supplied with power by the local power supply.

In the described examples, the different parts of the card selection apparatus 1 are connected by signal lines. This is not essential. In other examples signals may be carried between different parts of the apparatus by wireless means, for example infra-red signalling or Bluetooth™. In such examples the signals may be protected by suitable encryption.

In the described examples, the card receiving stations are all formed together in a single display body. This is not essential. In other examples the card receiving sections may be formed separately. The card receiving stations or display body may be formed as an integral part of a gaming table.

In other examples of playing the game, alternative methods of randomly selecting the card may be used.

In one alternative selection method, each card receiving station, or each face down card, may be associated with a number or colour. One number or colour can then be randomly selected, and the associated face down card will be the selected card.

A number or colour may be randomly selected in a number of ways, for example by rolling a dice with numbered or coloured faces, spinning a numbered or coloured wheel, spinning a pointer surrounded by numbered or coloured regions, bingo balls, an electronic random colour or number generating apparatus, or the like. The selection action, such as rolling a dice, or spinning a wheel, may be carried out by the dealer, or by a selected player.

In one alternative selection method, one player may be selected and allowed to pick a face down card which is to be the selected card. This will be random selection, regardless of the reasoning used by the player to pick the card, because the players do not know the identities of the face down cards.

In these methods, a player may be selected to take an action by the dealer, or may be identified by the game rules. For example, the player wagering the highest stake, or making the wager having the highest potential return, may be selected to take the action.

### Example 4

In this example, game play is similar to the examples set out above with the difference that a different playing area is used.

In a real-world example, the game is played on a casino table having a playing surface formed by a visual display screen with the playing area displayed or rendered on the display screen. This arrangement may allow a number of different games to be played on the same casino table by changing the displayed playing area. Commonly, such visual display screens are rectangular.

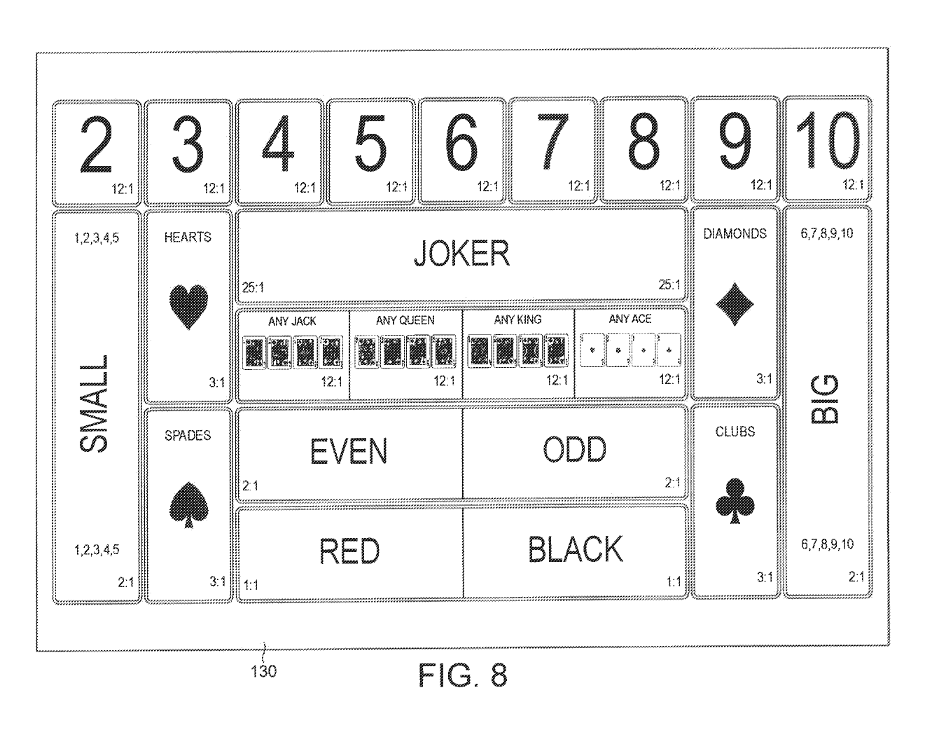

In a real-world example, the game is played on a casino table having a playing surface formed by a visual display screen similar with the playing area illustrated in FIG. 8 displayed or rendered on the display screen. The game play is similar to that described in relation to Example 1, except that a different playing area 130 is used.

The playing area 130 differs from the playing area 121 according to the second example mainly in that the playing area 130 has a different overall shape, so the different regions are shaped and arranged differently to fit this overall shape. The playing area 130 includes regions corresponding to all of the same wagers as the playing area 120.

### Example 5

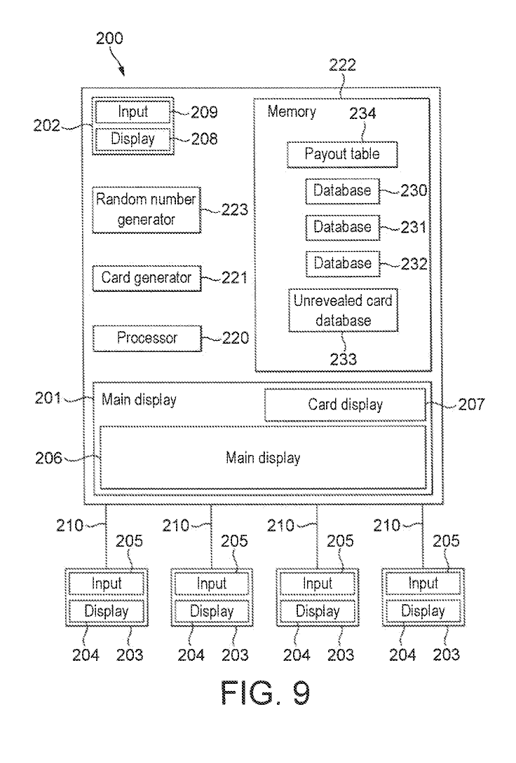

The examples described above relate to versions of the game played using real physical cards. An alternative example played on a game system displaying virtual cards on a visual display is illustrated in FIG. 9.

In the system illustrated in FIG. 9, a game machine 200 comprises a main display 201 and a dealer terminal 202, and is linked to a number of player terminals 203 by respective wireless communication links 210. The wireless communications links 210 may for example be infra-red or Bluetooth™ links, or a local communications network. The communications links may be protected by encryption.

Each player terminal 203 comprises a player display 204 for displaying information to a player, and player input means 205 to enable a player to place one or more wagers by selecting a wager based on a predicted parameter of the selected card and a wager amount. The input means 205 may be a conventional keyboard, or maybe a touch-screen device or a specialised keyboard adapted for inputting wager amounts and selecting wagers. Optionally, the player terminal 203 may display the identity of the selected card in previous rounds of the game. In some examples the display 204 and input means 205 may be combined in a touch screen display. Each player terminal 203 may include in its display 204 a field which shows a running total value of a player's account, this value being reduced as the player places a wager, and increased as the player receives winnings.

The main display 201 displays a playing area 206 and a card display 207.

The playing area 206 displays the available wagers. Optionally, the playing area 206 may display the payout odds for each of the available wagers. Optionally, the playing area 206 may display the wagers placed by the different players during game play. Optionally, the playing area 206 may identify the winning wagers when the identity of the selected card is revealed. The playing area 206 may for example be the playing area 130 according to example 4.

The card display 207 displays images of the backs of the six dealt cards, and then displays the face of the selected card when random selection has taken place. The card display may display the backs of the five non-selected cards together with the face of the selected card, so that the displayed images has the appearance of the selected card of the six face down cards being turned face up. Optionally, the card display 207 may display the identity of the selected card in previous rounds of the game.

The dealer terminal 202 comprises a dealer display 208, which may display some or all of the same information as the main display 206, and also displays dealer information regarding the progress and play of the game, and dealer input means 209 to enable the dealer to input commands controlling the progress of the game. The input means 209 may be a conventional keyboard, or maybe a touch-screen device or a specialised keyboard adapted for inputting game commands. In some examples the display 208 and input means 209 may be combined in a touch screen display.

The game machine 200 further comprises a processor 220, a card generator 221, a memory 222, and a random number generator 223.

The processor 220 is in overall control of the game, based on instructions stored in the memory 222. The memory 222 includes a payout table 234 which determine the amounts to be paid out to players on the basis of the result predicted by the player, the amount wagered, and the identity of the selected card.

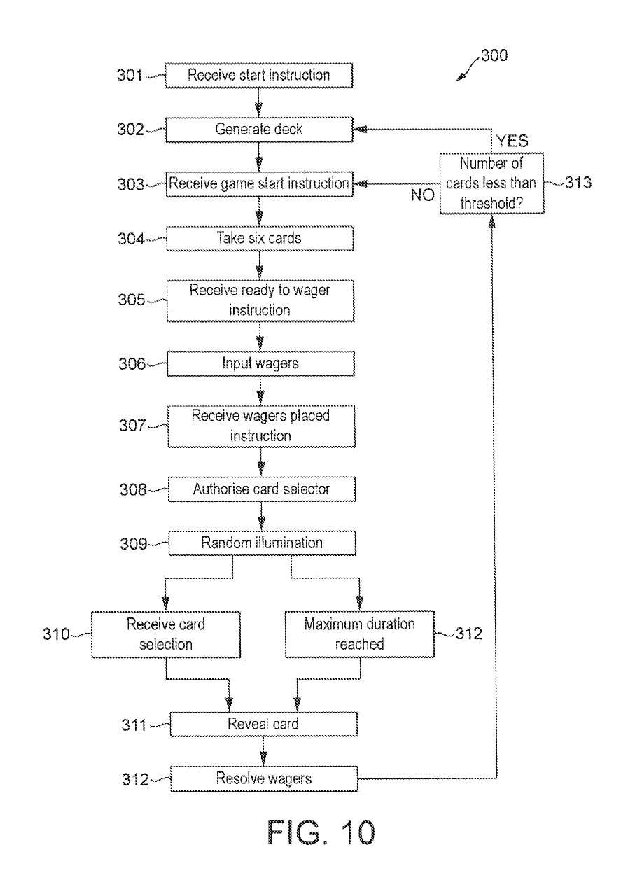

FIG. 10 illustrates a method 300 for playing the card game with rules as discussed above using the game machine 200.

In a first step 301 the processor 220 receives a game session start instruction input through the dealer input means 209 by the dealer.

Then, in a step 302, in response to the game session start instruction the processor 220 instructs the card generator 221 to generate the deck of cards to be used to play the game. The different displays 201, 206 and 208 of the game machine 200 may display a message indicating that the deck is being generated to indicate to players why the game cannot be played at this time. This message may optionally include a progress bar.

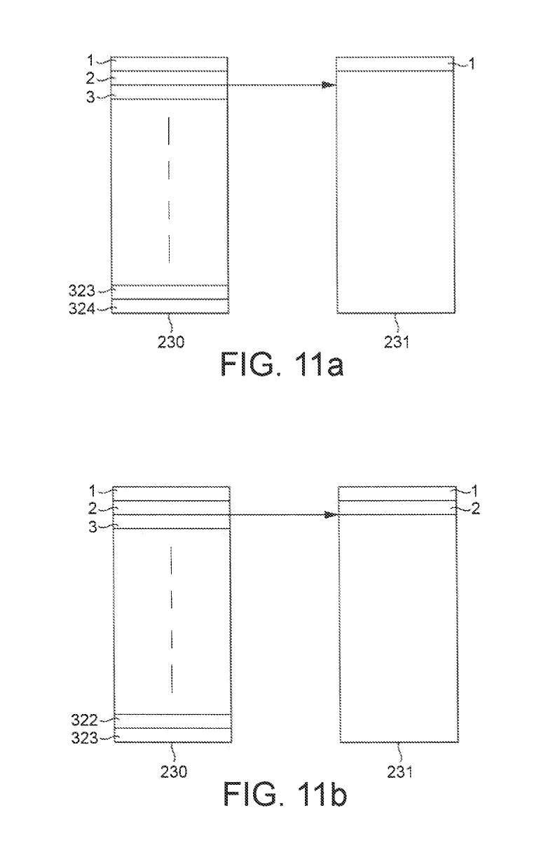

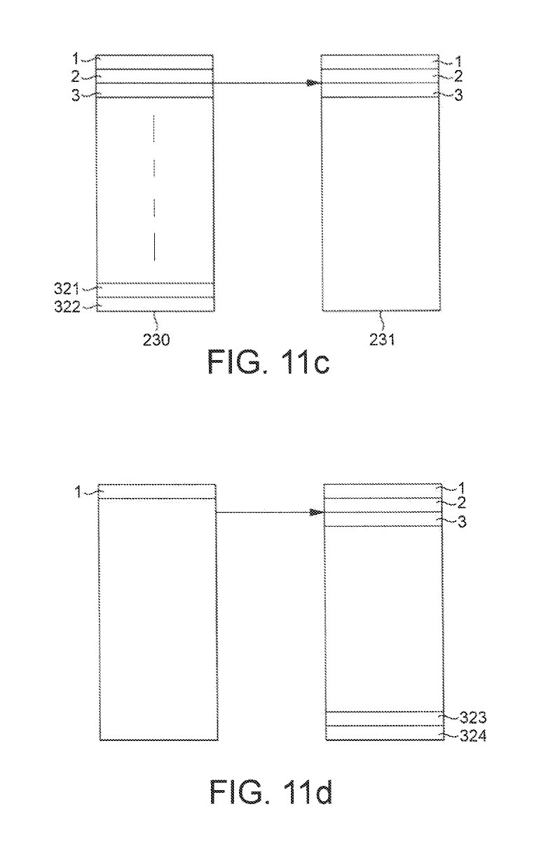

The card generator 221 generates the deck using first to third card databases 230 to 231 stored in the memory 222 by the following method illustrated schematically in FIGS. 11a to 11d.

Firstly, the card generator 221 generates an ordered deck comprising all of the cards to be used to play the game in the first database 230 arranged in a numbered sequence. The stored ordered deck comprises a card data value corresponding to each possible card position in the deck, with each card data value comprising data identifying the card. The card data values represent cards, and for brevity and clarity, these card data values will be referred to as cards herein. In the illustrated example where 6 packs of cards with two Jokers each are to be used, the ordered deck will comprise a total of 324 cards, that is, 6 each of the 52 cards in a conventional pack of cards and 12 Jokers. The ordered deck may be in the order of six conventional decks of cards with two Jokers each placed one after another, or any other convenient order. Since the card generator will shuffle the cards before use the starting order is irrelevant to game play.

Then, the card generator 221 shuffles the ordered deck in the first database 221 to form a shuffled deck in the second database 222. The shuffling process carried out by the card generator 221 is shown in FIG. 11a. The card generator 221 chooses a random one of the 324 cards in the first database 230. The randomly chosen card is chosen based on a random number in the range 1 to 324 provided by the random number generator 223, the chosen card having the sequence number corresponding to the random number is chosen. The randomly chosen card is then deleted from the first database 230, and is entered in a second database 231 as the first card in a numbered sequence. The first database 230 then contains 323 cards, and the second database 231 contains 1 card.

Next, as shown in FIG. 11b, the card generator 221 chooses a random one of the 323 cards in the first database 230 based on a random number in the range 1 to 323 provided by the random number generator 223. The randomly chosen card is then deleted from the first database 230, and is entered in the second database 231 as the next, second card in the numbered sequence. The first database 230 then contains 322 cards, and the second database 231 contains 2 cards.

Next, as shown in FIG. 11c, the card generator 221 chooses a random one of the 322 cards in the first database 230 based on a random number in the range 1 to 322 provided by the random number generator 223. The randomly chosen card is then deleted from the first database 230, and is entered in the second database 231 as the next, third card in the numbered sequence. The first database 230 then contains 321 cards, and the second database 231 contains 3 cards.

This process is continued until all of the cards in the first database 230 have been randomly chosen and entered sequentially in the numbered sequence in the second database 231.

In the last stage of this process, as shown in FIG. 11d, the only card remaining in the first database 230 is chosen and is entered in the second database 231 as the final card in the numbered sequence. The first database 230 then contains no cards, and the second database 231 contains 324 cards in a random order.

Next, the card generator 221 repeats the shuffling process to shuffle the shuffled deck in the second database 222 to form a twice shuffled deck in the third database 223.

As in the previous shuffling process, the card generator 221 chooses a random one of the 324 cards in the second database 231 based on a random number in the range 1 to 324 provided by the random number generator 223, the chosen card having the sequence number corresponding to the random number is chosen, and then deleted from the second database 231, and is entered in the third database 233 as the first card in a numbered sequence. The second database 322 then contains 323 cards, and the third database 233 contains 1 card.

This process is continued as before, until all of the cards in the second database 231 have been randomly chosen and entered sequentially in the numbered sequence in the third database 232.

Following this double shuffling, the numbered sequence of cards in the third database 232 will comprise cards in a random order.

The numbered sequence of randomly ordered cards in the third database 232 is then used as the deck of cards for playing the game.

When the deck generation has been completed the processor 220 displays a message on the dealer display 208 indicating that the game is ready to be played. Optionally, similar messages may be displayed on some or all of the other displays 201 and 204.

In step 303 the processor 220 receives a game start instruction input through the dealer input means 209 by the dealer.

Then, in a step 304, in response to the game start instruction, the processor 220 takes the first six cards in the numbered sequence stored in the third database 232, and assigns these six cards to respective ones of six unrevealed card positions. These six cards are then deleted from the numbered sequence stored in the third database 232. The processor stores the identity of the cards assigned to each of the six unrevealed card positions in an unrevealed card database 233 in the memory 222. The processor displays images of the backs of six cards on the card display 207, each corresponding to one of the six unrevealed card positions to indicate that the six concealed, or face down, cards have been selected. Optionally, images of the backs of the six cards are also displayed on the player displays 204. The processor 220 may optionally further display a prompt on the dealer display 208 indicating that the game machine 200 is ready to accept wagers.

In a step 305, the processor 220 receives a ready to receive wagers instruction input through the dealer input means 209 by the dealer.

Then, in a step 306, in response to the ready to receive wagers instruction, the processor 220 displays a message on the main display 201 and the player displays 204 indicating that wagers may be placed. This message may for example be “place your bets”. Each player can then use their player terminal 203 to input wager data comprising a predicted result and a wager amount, using the respective input means 205. The wager data is communicated to the processor 220 via the communications links 210, and is stored in memory 222.

In a step 307, the processor 220 receives a wagers placed instruction input through the dealer input means 209 by the dealer. The dealer inputs the instruction wagers placed instruction when the dealer determines that all players have placed their respective wagers. In response to the wagers placed instruction, the processor 220 stops accepting wagers from the player displays 204, and displays a message on the main display 201 and the player displays 204 indicating that no more wagers may be placed. This message may for example be “no more bets”.

Then, in a step 308, in response to the wagers placed instruction, the processor 220 randomly selects one of the player terminals 203 based on a random number generated by the random number generator 223 to be authorised to select the card, and displaying a select card message on the display 204 of that player terminal 203. Optionally, messages identifying the player terminal 203 authorised to carry out the selection may also be displayed on the player displays 204 of the other player terminals 203, and/or the main display 201, and/or the dealer display 208.

Then, in a step 309, the processor 220 successively illuminates random ones of illuminatable display areas each adjacent to one of the images of the backs of the cards corresponding to the six unrevealed card positions, each for a predetermined short time period, in a corresponding manner to the light illumination by the card selecting apparatus according to the third example. The displayed image may correspond to the display of the card selecting apparatus according to the third example as shown in and described with reference to FIGS. 6b and 6c, with the illuminatable display areas corresponding to the illustrated lights 4a to 4f.

The processor 220 is provided with a series of random numbers by the random number generator 223. The processor 220 uses the current random number in the series to choose one of the illuminatable display areas to be illuminated.

In one example the different ones of the illuminatable display areas may each be assigned a number in the range 1 to 6, and the random number generator may provide random numbers in the range 1 to 6. In response to each random number value the illuminatable display area which has been assigned the same value may be chosen to be illuminated. Different choosing methods may be used in other examples.

After a predetermined time period, the central processing module 12 uses the next random number in the series to chose one of the illuminatable display areas to be illuminated. Accordingly, randomly selected ones of the illuminatable display areas are illuminated for each of a series of the predetermined time periods.

When the process of randomly illuminating one of the illuminatable display areas for a predetermined period of time is repeated in the random illumination step 309, the predetermined time for which the chosen illuminatable display area is illuminated before the random selection is repeated is reduced on successive occasions until the predetermined time reaches a lower limit. This reduction in the successive illumination times may generate a perception of acceleration of events in players, and prompt players to input a card selection signal.

The provision of a lower limit is not essential. However, it may be preferred to select a lower limit based on the persistence of vision phenomenon in humans, so that when the predetermined time is at the lower limit observers will still be able to perceive successive illuminations of different illuminatable display areas.

In a first alternative procedure, the processor 220 receives a card selection signal through the authorised player terminal 203 before a predetermined maximum duration has expired in a receive card selection signal step 310.

Next, in the card revealing step 311, the processor 220 identifies the unrevealed card position adjacent to the illuminatable area being illuminated when the card selection signal was received as the selected card, recovers the card identity assigned to that unrevealed card position from the unrevealed card database 233, and displays an image of that recovered card in place of the image of the back of a card in that unrevealed card position of the card display 207. Optionally, the processor may also display this in the player displays 204 and the dealer display 208. Optionally, the processor 220 may also continue to illuminate the illuminatable area for a period of time.

In a second alternative procedure, the predetermined maximum duration expires without the processor 220 receiving a card selection signal, in a maximum duration reached step 24.

The processor 220 determines that the predetermined maximum duration has expired, and proceeds to the card revealing step 311.

In this case, in the card revealing step 311, the processor 220 identifies the unrevealed card position adjacent to the illuminatable area being illuminated when the predetermined maximum duration expired as the selected card, recovers the card identity assigned to that unrevealed card position from the unrevealed card database 233, and displays an image of that recovered card in place of the image of the back of a card in that unrevealed card position of the card display 207. Optionally, the processor may also display this in the player displays 204 and the dealer display 208. Optionally, the processor 220 may also continue to illuminate the illuminatable area for a period of time.

Then, in a step 312, the processor 220 resolves the game result by illuminating the areas of the playing area 206 corresponding to wagers which are winning wagers based on the identity of the randomly selected card, and using the payout table 234 and the wager data stored in memory 222 to identify winning wagers and the amount won. The processor 220 then credits any winning players with their respective winnings, and displays the fact that the player has won and the amount on the respective player display 204.

The six cards stored in the unrevealed card database 233 are then discarded. In alternative examples these cards may be retained, and overwritten in a subsequent game.

The game machine 200 then returns to step 303 ready to play another round of the game on receipt of a game start instruction input by the processor 220.

In the next game, the first six cards in the numbered sequence stored in the third database 232 are taken for use. It will be understood that since the taken six cards are deleted in each game, successive games will use successive groups of six cards from the numbered sequence stored in the third database 232.

Before returning to step 303 the processor compares the number of cards remaining in the numbered sequence stored in the third database 232 with a predetermined minimum value in a step 313. If the remaining number of cards is below the predetermined minimum value the method returns to step 302 to generate a new deck of cards for further play.

In other examples of playing the game, alternative methods of randomly selecting the card may be used.

In one alternative selection method, instead of the player authorised to carry out card selection being selected randomly, they may be selected by the dealer, or identified by the game rules. For example, the player wagering the highest stake, or making the wager having the highest potential return, may be selected to carry out card selection.

In one alternative selection method, the authorised player and allowed to directly pick a face down card which is to be the selected card. This will be random selection, regardless of the reasoning used by the player to pick the card, because the players do not know the identities of the face down cards.

In alternative examples, inputs from a plurality of different players may be used to generate the card selection signal in any convenient manner. For example, the first player to make an input may generate the card selection signal, or the card selection signal may be generated when a predetermined number of players have make a respective input.

In alternative examples other means of indicating which one of the face down cards is the selected card may be used.

In alternative examples a continuous deck of cards may be used where the taken six cards are retained in the deck, and the deck is shuffled between each game.

### Example 6

The example 5 related to versions of the game played using a game system displaying virtual cards on a visual display.

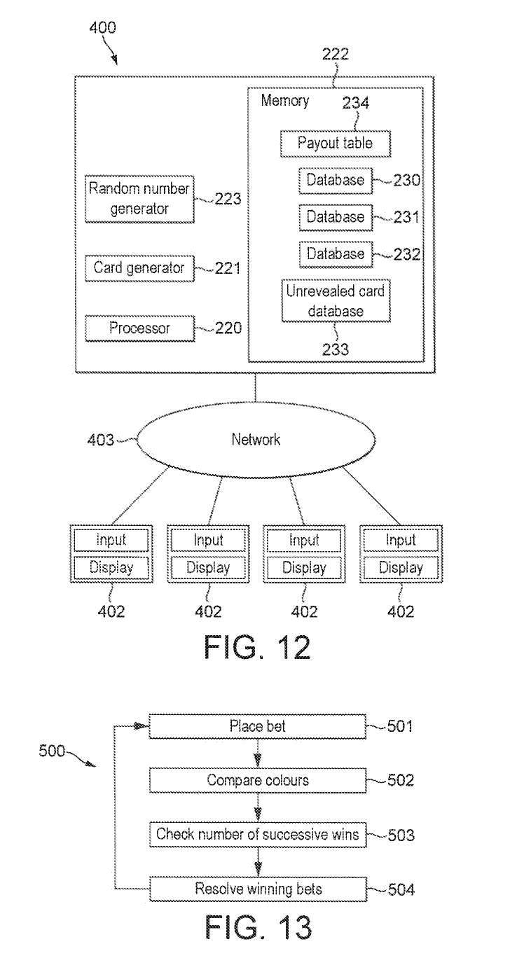

In the system illustrated in FIG. 12, the game may be played remotely using a networked game system 400 comprising a game server 401 that is linked to a number of player terminals 402 by a communications network 403 such as the Internet.

The player terminal 402 may be a desktop or laptop computer, or may be a pad computer or mobile telephone apparatus or any other mobile communications apparatus connectable to the communications network. The player terminal 402 has similar game functions to the player terminal 203 discussed above.

Operation of the networked game system 400 is similar to operation of the game machine 200, with the game server 401 comprising corresponding components to the game machine 200 with the main display 201 and dealer terminal 202 omitted. However, operation of the networked gaming system may be entirely automated so that no dealer is required. Further, no main display 201 is provided, so all necessary messages and information are displayed on the player terminals 402.

Accordingly, the networked game system 400 substantially follows the method of FIG. 10, but with dealer actions being made by a processor of the game server 401.

In step 301 the processor receives a game session start instruction input from an external game controller.

In step 303 the processor may receive a game start instruction input from one or more player terminals 402 of players who wish to play the game. The processor may display on each player terminal 402 an invitation to the player to place a bet and initiate a round of play.

Step 305 is omitted, and the processor proceeds directly from step 304 to step 306.

In step 307 the processor stops accepting wagers from the player terminals 402, and displays a message on the player terminals 402 indicating that no more wagers may be placed based on the length of time that has passed since wagers started being placed, and/or the length of time that has passed since any player placed a wager, and/or every player having placed at least one wager.

In step 312, depending on the player's selected wager, a congratulatory or commiseratory message may be displayed on each player terminal 402. The display will then revert to an invitation to the player to place a bet and initiate a further round of play.

### Example 7

The seventh example relates to a side game which may be played by players using a player terminal of the game machine of the fifth example, or a player terminal of the networked game system of the sixth example.

In the side game each of the cards in the deck which may be the selected card during play of the main game described above is assigned one of five colours, with the exception of the Jokers.

In one example, the Hearts numbered 1 to 10 may be assigned a yellow colour, the Diamonds numbered 1 to 10 may be assigned a red colour, Spades numbered 1 to 10 may be assigned a green colour, and Clubs numbered 1 to 10 may be assigned a blue colour. All picture cards, Jack, Queen or King of any suit, may be assigned an orange colour. The Jokers are assigned to have no colour.

FIG. 13 illustrates a method 500 for playing a side game with rules according to one embodiment of the seventh aspect of the present disclosure.

During the placing wagers part of the main game, after the six cards have been displayed face down, in a step 501, players wishing to play the side game may place a side bet by using their payer terminal to input wager details indicating one of the five colours and an amount wagered.

When the selected card is revealed in the main game, the indicated colours of the different player wagers are compared to the colour assigned to the selected card in a step 502.

Player wagers having an indicated colour which does not match the colour assigned to the selected card are losing wagers. Jokers are assigned no colour, and accordingly, if the selected card is a Joker all wagers are losing wagers. The amounts wagered on these losing wagers are taken by the house, and the corresponding players must make a new wager if they wish to continue playing the side game in subsequent rounds of the main game. A proportion of these lost wagers may be added to a cumulative jackpot value.

Player wagers having an indicated colour which does match the colour assigned to the selected card are winning wagers. These winning wagers are maintained into subsequent rounds of the main game without the corresponding players having to take any further action.

In a step 503, the number of times that each winning player wager has been a winning wager matching the colour of the selected card is checked.

The winning wagers are then resolved in step 504 based on the total consecutive number of times they have been winning wagers, based on the wager resolution table 3.

| Number of times won | Reward |
|---|---|
| 1 | none |
| 2 | none |
| 3 | Win amount wagered |
| 4 | Win twice amount wagered |
| 5 | Win three times amount wagered |
| 6 | Win 10% of jackpot |
| 7 | Win jackpot |

As shown in table 2, if they wager has won once or twice, no reward is given.

If the wager has won three times, the amount wagered is won.

If the wager has won four times, twice the amount wagered is won.

If the wager has won five times, three times the amount wagered is won.

If the wager has won six times, ten percent of jackpot is won.

If the wager has won seven times, the jackpot is won.

Optionally, if more than one player wins the jackpot at the same time, the jackpot will be split between the winning players.

The method then returns to step 501, where the winning wagers are automatically retained as wagers for the next round of the game.

The cards may be coloured in accordance with their assigned colours in the side game. Alternatively, when the selected card is revealed the colour assigned to the selected card may be indicated.

The side game of the seventh example may be played with other card games instead of the main game described above.

The above description refers to the placing of wagers having wager amounts, these wagers and amounts may be defined in terms of actual currency, or in terms of game credits. Similarly, winnings from winning wagers may be paid in currency or game credits.

The above description refers to random numbers and random selections. The terms random number and random selection should be interpreted as including pseudo-random numbers and pseudo-random selection respectively.

In other examples of playing the game, alternative methods of randomly selecting the card may be used.

In alternative examples the game could be played with wagers based directly on the identity of a randomly selected card without first dealing out a number of cards and selecting one of the cards from the number of cards.

The above examples of the invention provide a card game with increased player appeal and excitement of card game play.

The above example and embodiments have been described by way of example only and modifications are possible within the scope of the claims that follow.

1. A method of playing a wagering card game by at least one player, comprising the steps of:
drawing a plurality of cards from a deck of cards to form a group of cards without revealing the identities of the group of cards;
providing the opportunity for a player to place a wager by predicting a winning criteria related to a possible card identity;
randomly selecting one of the group of cards and revealing the identity of the selected card;
comparing the identity of the selected card to the criteria of the player wager; and
settling the player's wager on the basis of the comparison.

2. A method according to claim 1, wherein in the step of providing the opportunity for a player to place a wager further comprises choosing an amount to wager.

3. A method according to claim 1, wherein the step of placing a wager comprises placing a coin, banknote or gambling chip in a designated betting region of a game table.

4. A method according to claim 1, wherein the deck of cards comprise one or more standard packs of playing cards.

5. A method according to claim 4, wherein the deck of cards comprises five standard packs of playing cards.

6. A method according to claim 4, wherein the deck of cards comprises six standard packs of playing cards.

7. A method according to claim 4, wherein the, or each, pack of playing cards comprises two Jokers.

8. A method according to claim 1, wherein the step of settling the player's wager comprises determining whether the prediction made by the player coincides with the selected card, and paying winnings to the player on the basis of that determination, the amount of the wager, and a predetermined payout schedule.

9. A method according to claim 3, wherein the step of paying winnings to the player comprises placing coins, banknotes or gambling chips in the designated betting region of the game table.

10. A method according to claim 1, wherein the random selection of one card is made by a random card selection apparatus.

11. A method according to claim 1, wherein the random selection of one card is made by rolling a dice.

12. A method according to claim 1, wherein the group of cards are laid out face down on a gaming surface.

13. A method according to claim 12, wherein the selected cards are placed face up on the gaming surface.

14. A method according to claim 1, wherein the group of cards comprises six cards.

15. A gaming machine comprising:
a display screen for displaying a selected card to a player;
input means to allow a player to input wager information comprising a prediction of a winning criteria related to a possible card identity;
a memory for storing the wager information;
a processor operable to:
receive the wager information and store it in the memory;
randomly generate a plurality of cards from a deck of cards to form a group of cards without revealing the identities of the group of cards;
randomly select one of the group of cards and reveal the identity of the selected card; and
determine the result of the wager by comparing the identity of the selected card to the criteria of the stored player wager;
determine an amount of winnings payable to the player; and
communicate the amount of winnings to the player, via the display screen.

16. A gaming machine according to claim 15 wherein the input means allows a player to input wager information comprising an amount to wager.

17. A gaming machine according to claim 15 wherein the deck of cards comprise one or more standard packs of playing cards.

18. A gaming machine according to claim 17, wherein the deck of cards comprises five standard packs of playing cards.

19. A gaming machine according to claim 17, wherein the deck of cards comprises six standard packs of playing cards.

20. A gaming machine according to claim 17, wherein the, or each, pack of playing cards comprises two Jokers.

21. A gaming machine according to claim 15 wherein the processor is operable to determine the result of the wager by determining whether the prediction made by the player coincides with the selected card, and paying winnings to the player on the basis of that determination and a predetermined payout schedule.

22. A gaming machine according to claim 15 wherein the group of cards comprises six cards.

23. A gaming system comprising a gaming server and a plurality of gaming terminals, the gaming server and the said plurality of gaming terminals being linked by a communications network, wherein each of the gaming terminals comprises:
a display screen for displaying a selected card to a player; and
input means to allow a player to input wager information comprising a prediction of a winning criteria related to a possible card identity;
and wherein the gaming server comprises:
a card generator for generating card data representing randomly-selected playing cards;
a memory in which is stored:
a payout table storing correlations between a selected card identity, a predicted result, and an amount to be paid; and
received player wager information;
and a processor operable to:
randomly generate a plurality of cards from a deck of cards to form a group of cards without revealing the identities of the group of cards;
receive betting information from at least one player terminal;
randomly select one of the group of cards and reveal the identity of the selected card;
transmit card data for the selected card to the gaming terminals for display;
determine a result of the wager by comparing the identity of the selected card to the criteria of the stored player wager; and
settle each player's wager on the basis of the predicted result, the selected card, and the payout table.

24. A gaming system according to claim 23 wherein the input means allows a player to input wager information comprising an amount to wager.

25. A gaming system according to claim 23 wherein the deck of cards comprise one or more standard packs of playing cards.

26. A gaming system according to claim 25, wherein the deck of cards comprises five standard packs of playing cards.

27. A gaming system according to claim 25, wherein the deck of cards comprises six standard packs of playing cards.

28. A gaming system according to claim 25, wherein the, or each, pack of playing cards comprises two Jokers.

29. A gaming system according to claim 23 wherein the processor is operable to determine the result of the wager by determining whether the prediction made by the player coincides with the selected card, and paying winnings to the player on the basis of that determination and a predetermined payout schedule.

30. A gaming system according to claim 23 wherein the group of cards comprises six cards.

31. A non-transitory computer readable medium including a software program or a plurality of software programs which, when executed, enables a gaming machine to provide to at least one player a wagering card game comprising the steps of:
receiving wager data representing a player's wager, the wager data comprising a prediction of a winning criteria related to a possible card identity, from a player at a player terminal;
randomly generating a plurality of cards from a deck of cards to form a group of cards without revealing the identities of the group of cards;
randomly selecting one of the group of cards and reveal the identity of the selected card; and
determining the result of the wager by comparing the identity of the selected card to the criteria of the stored player wager;
determining an amount of winnings payable to the player; and
settling the player's wager on the basis of the determined result of the deal and the bet data.

32. The medium of claim 31, wherein the wager data comprises an amount to wager.

33. The medium of claim 31, wherein the deck of cards comprise one or more standard packs of playing cards.

34. The medium of claim 33, wherein the deck of cards comprises five standard packs of playing cards.

35. The medium of claim 33, wherein the deck of cards comprises six standard packs of playing cards.

36. The medium of claim 33, wherein the, or each, pack of playing cards comprises two Jokers.

37. The medium of claim 31, wherein the result of the wager is determined by determining whether the prediction made by the player coincides with the selected card, and paying winnings to the player on the basis of that determination and a predetermined payout schedule.

38. The medium of claim 31, wherein the group of cards comprises six cards.

39. A gaming table for playing the card game of claim 1, the gaming table comprising:
a dealer position intermediate the length of a first side of the table;
a card dealing area delineated on the table adjacent the dealer position, to receive the group of cards;
a number of player positions spaced along a second side of the table opposite the first side;
a plurality of wager regions distributed across the gaming table, with different wager regions corresponding to respective predicted winning criteria related to a possible card identity.

40. A gaming table according to claim 39, wherein the table is generally semicircular and has a straight first side and an arcuate second side.

41. A method of playing a wagering card game by at least one player, using a gaming apparatus comprising:
one or more decks of playing cards;
a card shuffling and dealing apparatus;
a gaming table having delineated thereon:
a card dealing area;
a number of player positions;
a plurality of wager regions distributed across the gaming table, with different wager regions corresponding to respective predicted winning criteria related to a possible card identity;
random selection means; and
tokens for representing the value of a wager;
the method comprising the steps of:
delivering, from the shuffling and dealing apparatus, a plurality of cards from a deck of cards to form a group of cards face down on the card dealing area;
the player placing a wager on a possible game outcome, by positioning a number of tokens to the amount of the wager in a wager region associated with the player's predicted winning criteria;
using the random selection means, randomly selecting one of the group of cards and placing the selected card face up on the card dealing area;
determining the outcome of the game by comparing the identity of the selected card to the criteria of the player wager, by either:
placing a number of additional tokens in the wager region in which the tokens forming the wager were positioned; or
removing the tokens positioned in the wager region by the player.

42. A method of playing a wagering card game according to claim 41, wherein the gaming apparatus further comprises a payout table correlating:
the prediction on which the player wagered;
the identity of the selected card; and
an amount of winnings to be paid to a player;
and wherein the step of settling the player's wager comprises determining the amount of winnings to be paid on the basis of the prediction on which the player wagered, the identity of the selected card, the amount of the wager and the corresponding amount set out in the payout table.

43. A method of playing a wagering card game by at least one player, comprising the steps of:
associating card identities of a deck of cards with different ones of a plurality of colours;
providing the opportunity for a player to place a wager by predicting the colour associated with a card to be selected;
selecting a card;
determining whether the player prediction is correct by determining whether the colour associated with the card identity of the selected card is the same as the player prediction;
if the player prediction is correct, repeating the same player prediction for a subsequent selected card;
comparing the number of consecutive times the player prediction is correct to a results table; and
settling the player's wager on the basis of the comparison.
